(19) United States
(12) Patent Application Publication
(10) Pub. No.: US 2007/0294718 A1
(43) Pub. Date: Dec. 20, 2007

(54) Parental control apparatus

(75) Inventor: Shinji Fujita, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/808,072

(22) Filed: Jun. 6, 2007

(30) Foreign Application Priority Data
Jun. 16, 2006 (JP) P2006-167359

(51) Int. Cl. H04N 7/167; H04N 7/16

(52) U.S. Cl. 725/31; 725/25

(57) ABSTRACT

A first memory stores a first level. A comparator is operable to compare the stored first level with a second level which corresponds to image information. A processor is operable to process the image information. A color controller is operable to control the processor so as to control a color component of the image information in accordance with a comparison result of the comparator.

The disclosure of Japanese Patent Application No. 2006-167359 filed Jun. 16, 2006 including specification, drawings and claims is incorporated herein by reference in its entirety.

### BACKGROUND

The present invention relates to a parental control apparatus for restricting a viewer from watching a video signal for a TV broadcast and a video signal recorded on a recording medium, such as an optical disk or the like.

Digital data (a bit stream) into which a video signal and a sound signal are encoded/compressed is recorded on a recording medium such as an optical disk, and is read and reproduced from the recording medium. A DVD (Digital Versatile Disk) is an example of such an optical disk.

When reproducing a video recorded on the DVD or watching a program of a TV broadcast, there are some contents of the video or the program that parents do not want their children to watch. A parental lock (parental control) function in which the video or the program (or a channel) is prohibited from being output by making a predetermined setting thereon has been put into practical use.

In a DVD system, it is possible to set level information (from level 1 to level 8; hereinafter called a parental level) for a program (the entire program or a part of the program) including a video recorded on a disk and to record the level information together with the program. The parental level for the program is related to limitation for reproducing the program. It is also possible to set a parental level for a DVD player. The parental level for the DVD player sets a limit on the parental level for the program which the DVD player is allowed to reproduce. The parental rock function is implemented based on these parental levels. Specifically, when reproducing a program (video) from a disk, the DVD player compares a parental level imparted to the program with a parental level set on the DVD player. In a case where the parental level imparted to the program is lower than the parental level set on the player, the player reproduces the program. If the parental level set on the player is set to level 8, the player can reproduce all programs. On the other hand, in a case where the parental level imparted to the program is equal to or higher than the parental level set on the player, the player is prohibited to reproduce the program (the entire program or a part of the program). In this case, the player may suspend reproducing the program, skip the part of the program, or alternatively reproduce a video which is prepared in the player. Meanwhile, in this specification, the bigger a number of the parental level is, the lower the parental level is. Namely, the parental level 8 is lower than the parental level 1.

The DVD player can selectively restrict the program from being reproduced on the basis of the parental levels by activating the parental lock function. This selective restriction depends on whether the parental lock function is activated or deactivated, and on the parental level set on the player. For this reason, the player may be configured to require a user to input a pre-registered password when activating/deactivating the parental rock function and changing the parental level set on the player. Accordingly, only a specific user (e.g. a parent) who knows the pre-registered password can activate/deactivate the parental lock function or change the parental level set on the player.

Japanese Patent Publication No. 2001-16514A discloses a display device with a recognition function. The display device, such as a TV monitor with an iris recognition camera for capturing an iris pattern of the eye of a viewer can identify the viewer on the basis of the captured iris pattern. In a case where the identified viewer is an infant or a minor, when a screen which is considered to provide an adverse effect on the identified viewer has appeared, the device switches a channel, issues a warning, or shut down itself.

Japanese Patent Publication No. 2005-86513A discloses a method for control a broadcasting receiver. In the method, when the broadcasting receiver receives a digital broadcast, information indicating an age limit for watching a selected program is detected, a brightness or a sound of the program is suppressed in a case where the program has the age limit, and the program with the suppressed brightness or the suppressed sound is output to an image output section and a sound output section.

In the related art, a viewer is completely restricted from viewing image information having a parental level which is equal to or higher than a parental level set by a parental lock. Therefore, it is a problem that the viewer cannot understand a story of the viewing program.

### SUMMARY

It is therefore an object of the invention to provide a parental control apparatus which can perform a limitation on viewing without impairing understanding of the story of the program.

In order to achieve the above described object, according to the invention, there is provided a parental control apparatus, comprising:

a first memory storing a first level;

a comparator operable to compare the stored first level with a second level which corresponds to image information;

a processor operable to process the image information; and

a color controller operable to control the processor so as to control a color component of the image information in accordance with a comparison result of the comparator.

With this configuration, the color component of the image information can be controlled in accordance with settings of the first level and the second level without completely restricting the viewer from viewing the image information. As a result, an adverse effect by the image information (a reproduced video) on the viewer can be decreased without impairing understanding of the story of the video.

The parental control apparatus may further comprise a decoder operable to decode the image information and the second level which corresponds to the image information, wherein:

the comparator is operable to compare the stored first level with the decoded second level; and

the processor is operable to process the decoded image information.

The color controller may be operable to transmit a color control signal to the processor so as to control the color component of the image information in accordance with the comparison result of the comparator.

The color controller may be operable to control the processor so as to control a color component amplitude of the image information in accordance with the comparison result of the comparator and an attenuation rate for the color component amplitude, which corresponds to the stored first level.

With this configuration, the viewer can ascertain the second level of the current reproduced image information (video).

The image information and the second level may be read from a recording medium.

With this configuration, the image information read from the recording medium can be subjected to the limitation on viewing.

The image information and the second level may be received from a broadcast signal.

With this configuration, the image information received from the broadcast signal can be subjected to the limitation on viewing.

The parental control apparatus may further comprise a second memory storing an authentication password for enabling the first memory to rewrite the first level.

The parental control apparatus may further comprise an input section operable to input a password and a level.

The parental control apparatus may further comprise a rewriting section operable to rewrite the stored first level by the input level only when the input password conforms to the stored authentication password.

With this configuration, only an administrator such as a parent can rewrite first level. Then, a person other than the administrator can be prevented from freely rewriting the first level.

According to the invention, there is also provided a parental control apparatus, comprising:

decoding means for decoding image information and a parental level which corresponds to the image information, which are stored in a optical disk;

first storing means for storing a limit level;

second storing means for storing an authentication password for enabling the first storing means to rewrite the limit level;

input means for inputting a password and a level;

rewriting means for rewriting the stored limit level by the input level only when the input password conforms to the stored authentication password;

comparing means for comparing the limit level with the parental level;

processing means for processing the image information; and

color controlling means for transmitting a color control signal to the processing means so as to control a color component amplitude of the image information in accordance with a comparison result of the comparing means and an attenuation rate for the color component amplitude, which corresponds to the stored limit level.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a first embodiment of the present invention;

FIG. 2 is a flowchart showing an operation of color controller according to the first embodiment of the invention;

FIG. 3 is a flowchart showing an operation for rewriting a first parental level according to the first embodiment of the invention;

FIG. 4 is a table showing a relationship between the first parental level and its content;

FIG. 5 is a table showing a relationship between the first parental level and its control of a color component amplitude;

FIGS. 6(A) to 6(C) are views showing a relationship between the first parental level, a second parental level, and the color component amplitude according to the first embodiment of the invention;

FIG. 7 is a view showing a relationship between the first parental level, the second parental level, and the color component amplitude according to a second embodiment of the invention;

FIG. 8 is a view showing ordinary one horizontal period of the color component amplitude in a color bar signal; and

FIG. 9 is a view showing controlled one horizontal period of the color component amplitude in the color bar signal.

### DETAILED DESCRIPTION OF THE EMBODIMENTS

Hereinafter, an embodiment of a parental control apparatus according to the invention will be discussed with reference to the accompanying drawings.

### First Embodiment

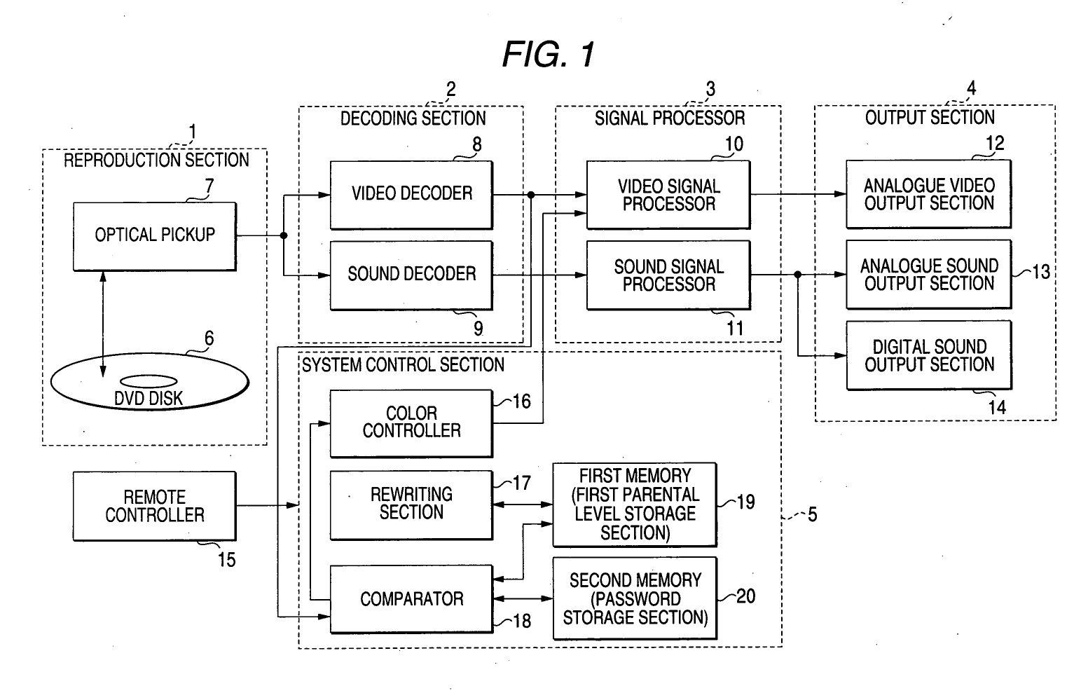

A first embodiment of the present invention will be described in detail by reference to the drawings. A movie is recorded on a DVD disk 6 shown in FIG. 1, and video data of the movie and a second parental level showing a sexual level and a violence level of the video data are included in the disk. The data is read from the DVD disk 6 by an optical pickup 7, and the read data is decoded into a video signal and a sound signal by a decoding section 2. The decoded video and sound signals are sent to a signal processor 3.

Next, a user inputs a first parental level via a remote controller 15, and the input first parental level is stored in first memory 19. The first parental level is protected by a password to restrict a person other than an administrator, such as a parent, from rewriting the first parental level.

The administrator inputs an authentication password via the remote controller 15, and the input authentication password is stored in second memory. Then, it is required to enter the input authentication password in order to rewrite the first parental level.

The second parental level is decoded by the decoding section 2 as well as the video data. A system control section 5 receives the decoded second parental level and comparator 18 compares the received second parental level with the preset first parental level stored in the first memory 19. When the second parental level is lower than the first parental level, color controller 16 sends a control signal to a video signal processor 10. The video signal processor controls a color component amplitude of the video signal in accordance with the control signal, and an analogue video output section 12 of an output section 4 receives a video signal whose color component is reduced.

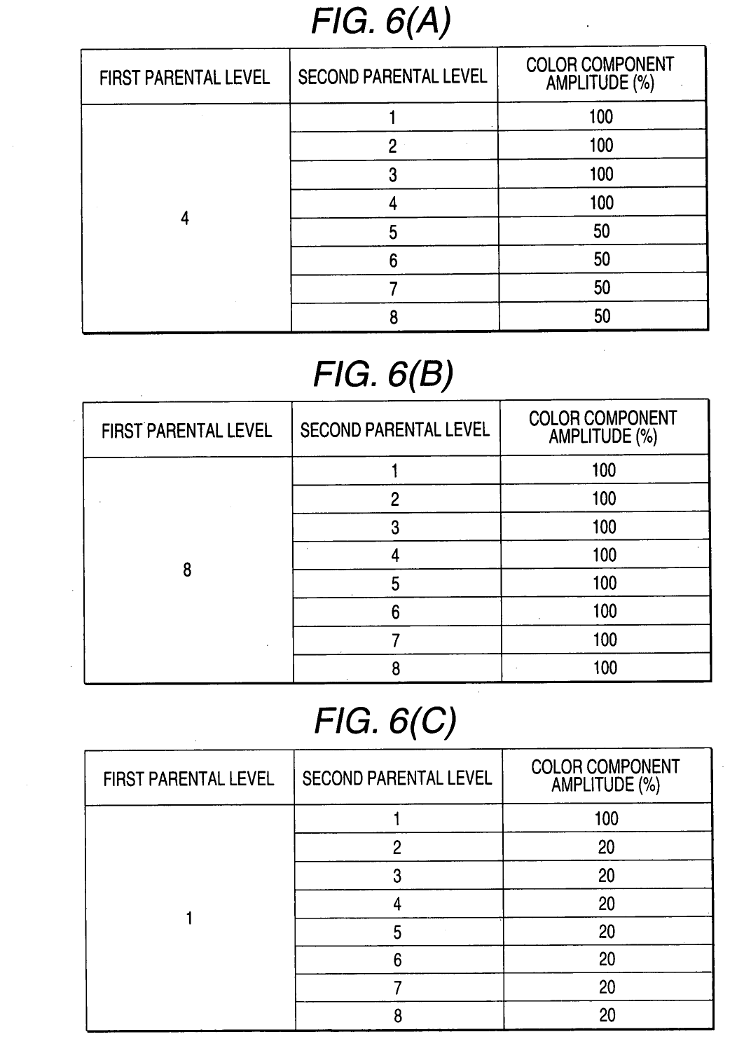

As shown in FIG. 6 (A), in a case where the first parental level is set to level 4, an ordinary color component amplitude of 1 Vp-p is attenuated by 50% and controlled to 500 mVp-p when the second parental level is lower than level 4 (i.e. level 5 to level 8). Specifically, when the second parental level is in a range from level 5 to level 8, an attenuation rate of the color component amplitude is 50%, and the color component amplitude of the video signal is reduced to 500 mVp-p.

On the other hand, when the second parental level is equal to or higher than the first parental level, in other words, when the second parental level is in a range from level 1 to level 4, the color component amplitude of the video signal is sent to an analogue video output section 12 at the ordinary color component amplitude of 1 Vp-p.

As shown in FIG. 6(B), in a case where the first parental level is set to level 8, the color component amplitude of the video signal is sent to the analogue video output section 12 at the ordinary color component amplitude of 1 Vp-p regardless of the second parental level corresponding to the video signal.

As shown in FIG. 6(C), in a case where the first parental level is set to level 1, the color component amplitude of the video signal is attenuated by 80% and controlled to 200 mVp-p when the second parental level is lower than level 1 (i.e. level 2 to level 8). The attenuation rate of the color component amplitude is 80% in this case. On the other hand, only when the second parental level is set to level 1, the color component amplitude of the video signal is sent to the analogue video output section 12 at the ordinary color component amplitude of 1 Vp-p. The attenuation rate of the color component amplitude is 0% in this case.

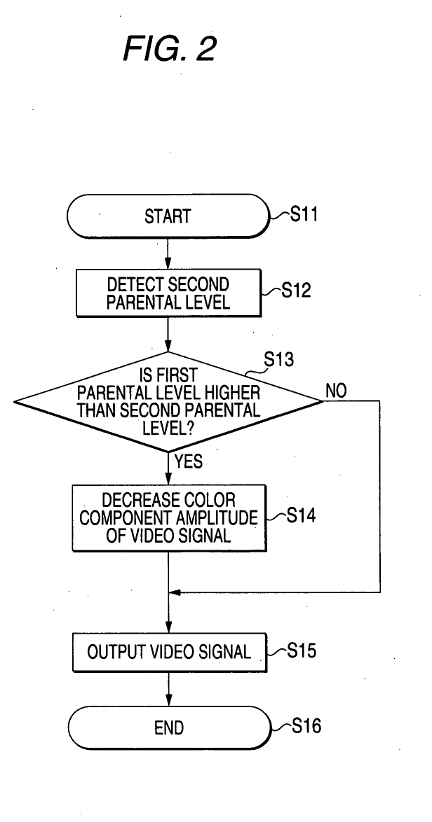

Next, the first embodiment is described by reference to a flowchart shown in FIG. 2. A second parental level is detected from the data read from the DVD disk (S12). It is determined whether the first parental level set by the user is higher than a second parental level detected in S12 (S13). When a result is YES, the color component amplitude of the video signal is reduced (S14), and the video is output (S15). On the other hand, when the result is NO in S13, process of S14 is skipped, and the color component amplitude of the video signal is output as is.

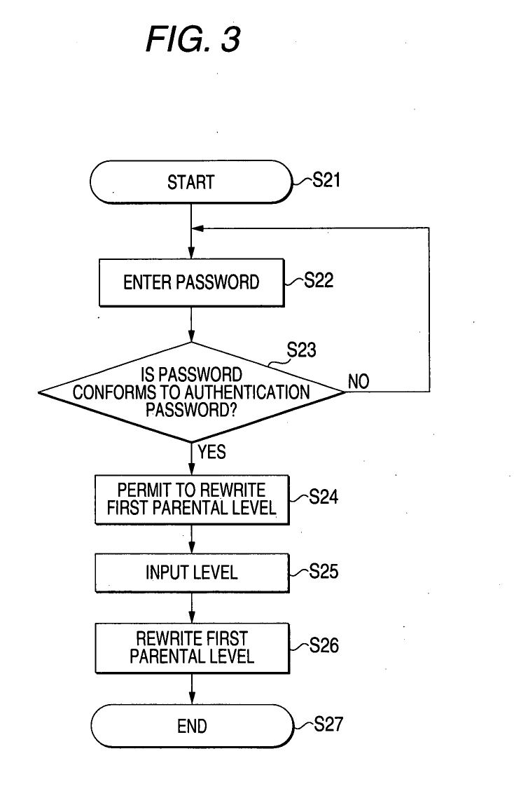

Next, an operation for rewriting the first parental level will now be described by reference to a flowchart shown in FIG. 3.

The user enters a password (S22), and the entered password is compared with the pre-registered authentication password (S23). It is permitted that the first parental level is rewritten when the entered password conforms to the authentication password (S24). Then, when the user inputs an arbitrary level as the new first parental level (S25), the first parental level is rewritten (S26).

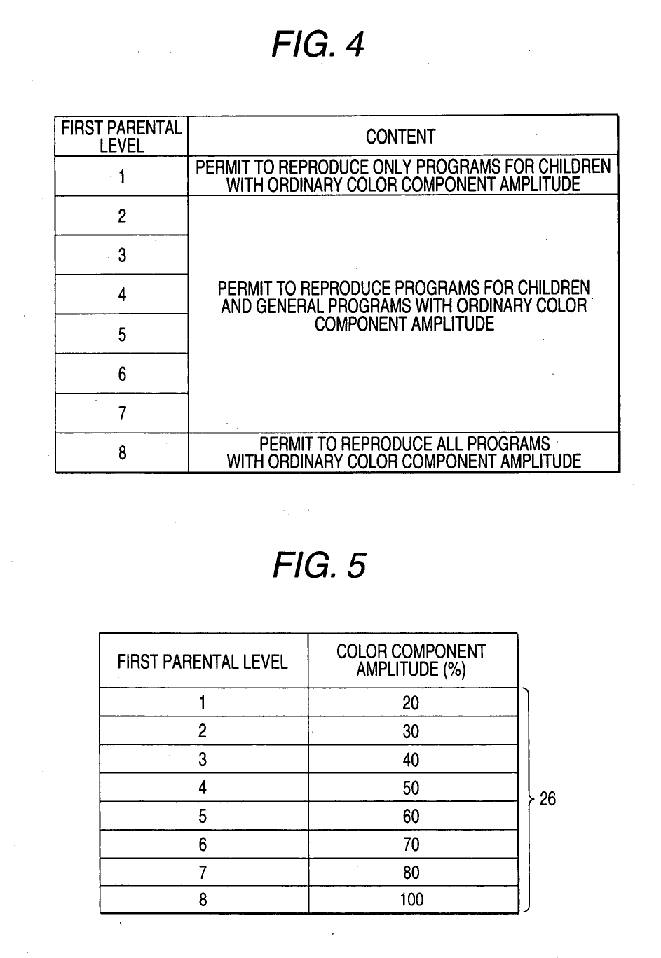

As shown in FIG. 4, when the first parental level is set to lower level, the viewer can watch a program including higher sexual and violence contents with the ordinary color component amplitude of 1 Vp-p. On the other hand, when the first parental level is set to higher level, the viewer is more strictly restricted from watching the program.

As shown in FIG. 5, the higher the first parental level is, the smaller the color component amplitude is. Namely, when the first parental level is set higher level, the attenuation rate of the color component amplitude is also set higher rate, then the data to be reproduced become more colorless and approximate monochrome. When the first parental level is set to a level higher than level 1, the data to be reproduced become completely colorless and monochrome.

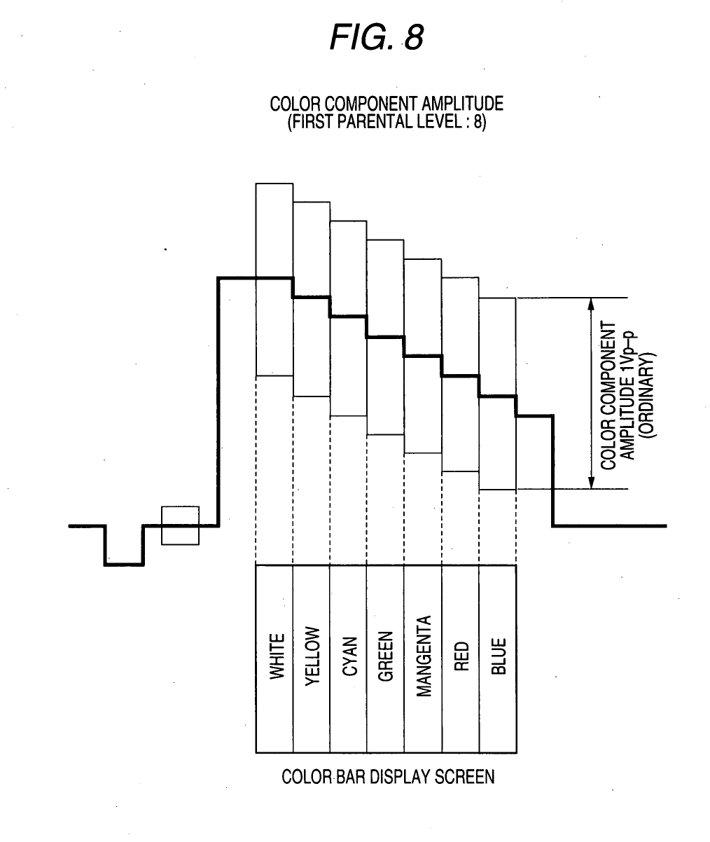

The color component amplitude of the video signal will now be described by reference to FIG. 8. FIG. 8 shows one horizontal period corresponding to a color bar display screen and when the color component amplitude is the ordinary amplitude of 1 Vp-p. A color burst signal includes basic signal components required to color-demodulate a color component. As indicated in the color bar display, color bars are arranged in sequence from left as white, yellow, cyan, green, magenta, red, and blue; and a brightness level of each of the color bars become lower in this sequence. A stepwise solid line represents the brightness level which represents the degree of brightness. Since the brightness level corresponds to a DC component, higher brightness is acquired with an increase in the brightness level. The color component is superimposed on this brightness level 23, and the color component amplitude is usually set to and designed at 1 Vp-p.

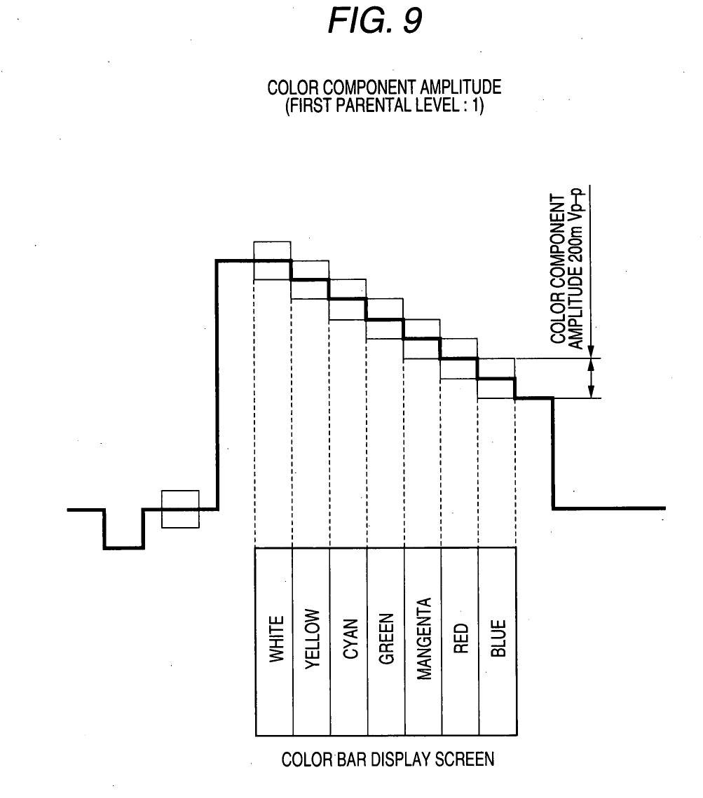

The color component amplitude controlled in accordance with the present invention will now be described by reference to FIG. 9. When the first parental level is set to level 1 and when the second parental level of the video signal is 2 or less, the color component amplitude is attenuated and controlled to 200 mVp-p.

### Second Embodiment

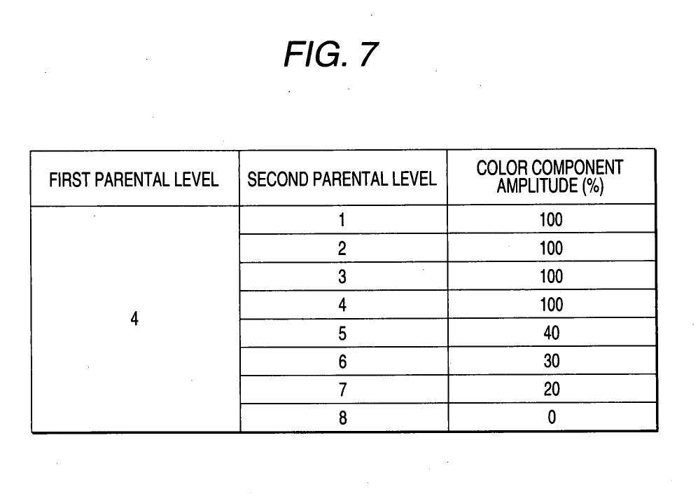

A second embodiment of the present invention will now be described. An explanation is given by reference to a table shown in FIG. 7. When the first parental level is set to level 4 and the second parental level is level 8, the ordinary color component amplitude of 1 Vp-p is attenuated to 400 mVp-p by the attenuation rate of 100%, then the color component amplitude is limited to 0%. When the second parental level comes to level 7, the attenuation rate comes to 80%, then the color component amplitude is limited to 20%. When the second parental level comes to level 6, the attenuation rate comes to 70%, then the color component amplitude is limited to 30%. When the second parental level comes to level 5, the attenuation rate comes to 60%, then the color component amplitude is limited to 40%. When the second parental level becomes lower than the preset first parental level, the color component amplitude is gradually attenuated in accordance with the second parental level. In other respects, the entire flow of a signal and the flowchart are the same as those mentioned in connection with the first embodiment.

The present invention can also be applied to a rating system adopted for a TV broadcast signal, such as a V-CHIP or the like, stipulated by the FCC radio standards of the U.S. The invention is not limited to the parental lock in the DVD player described in connection with the embodiments.

The first memory and the second memory are not necessarily two independent pieces of memory. A single memory may be divided into a first region as the first memory and a second region as the second memory, and the first parental level and the authentication password may be stored in the respective regions.

What is claimed is:

1. A parental control apparatus, comprising:
decoding means for decoding image information and a parental level which corresponds to the image information, which are stored in a optical disk;
first storing means for storing a limit level;
second storing means for storing an authentication password for enabling the first storing means to rewrite the limit level;
input means for inputting a password and a level;
rewriting means for rewriting the stored limit level by the input level only when the input password conforms to the stored authentication password;
comparing means for comparing the limit level with the parental level;
processing means for processing the image information; and
color controlling means for transmitting a color control signal to the processing means so as to control a color component amplitude of the image information in accordance with a comparison result of the comparing means and an attenuation rate for the color component amplitude, which corresponds to the stored limit level.

2. A parental control apparatus, comprising:
a first memory storing a first level;
a comparator operable to compare the stored first level with a second level which corresponds to image information;
a processor operable to process the image information; and
a color controller operable to control the processor so as to control a color component of the image information in accordance with a comparison result of the comparator.

3. The parental control apparatus as set forth in claim 2, further comprising a decoder operable to decode the image information and the second level which corresponds to the image information, wherein:
the comparator is operable to compare the stored first level with the decoded second level; and
the processor is operable to process the decoded image information.

4. The parental control apparatus as set forth in claim 2, wherein the color controller is operable to transmit a color control signal to the processor so as to control the color component of the image information in accordance with the comparison result of the comparator.

5. The parental control apparatus as set forth in claim 2, wherein the color controller is operable to control the processor so as to control a color component amplitude of the image information in accordance with the comparison result of the comparator and an attenuation rate for the color component amplitude, which corresponds to the stored first level.

6. The parental control apparatus as set forth in claim 2, wherein the image information and the second level are read from a recording medium.

7. The parental control apparatus as set forth in claim 2, wherein the image information and the second level are received from a broadcast signal.

8. The parental control apparatus as set forth in claim 2, further comprising a second memory storing an authentication password for enabling the first memory to rewrite the first level.

9. The parental control apparatus as set forth in claim 8, further comprising an input section operable to input a password and a level.

10. The parental control apparatus as set forth in claim 9, further comprising a rewriting section operable to rewrite the stored first level by the input level only when the input password conforms to the stored authentication password.
